(19) United States
(12) Patent Application Publication
(10) Pub. No.: US 2018/0255842 A1
(43) Pub. Date: Sep. 13, 2018

(54) Interactive Object with Multiple Electronics Modules

(71) Applicant: Google LLC, Mountain View, CA (US)

(72) Inventor: Mustafa Emre Karagozler, Mountain View, CA (US)

(21) Appl. No.: 15/799,182

(22) Filed: Oct. 31, 2017

Related U.S. Application Data
(60) Provisional application No. 62/469,233, filed on Mar. 9, 2017.

(51) Int. Cl. A41D 1/00; A41D 3/00; D03D 1/00; G06F 3/0354; G06F 3/038; G06F 3/044

(52) U.S. Cl. CPC A41D 1/005; A41D 3/00; D03D 1/0088; G06F 2203/0384; G06F 3/0383; G06F 3/044; G06F 3/03547

(57) ABSTRACT

This document describes an interactive object with multiple electronics modules. An interactive object (e.g., a garment) includes a plurality of conductive threads woven into the interactive object, and an internal electronics module coupled to the grid of conductive thread. The internal electronics module includes a first subset of electronic components, such as sensing circuitry configured to detect touch-input to the grid of conductive thread. An external electronics module that includes a second subset of electronic components (e.g., a microprocessor, power source, or network interface) is removably coupled to the interactive object via a communication interface. The communication interface enables communication between the internal electronics module and the external electronics module when the external electronics module is coupled to the interactive object.

### RELATED APPLICATIONS

The present application claims priority to U.S. Provisional Patent Application Ser. No. 62/469,233, filed on Mar. 9, 2017, which is incorporated herein by reference.

### BACKGROUND

Electronics embedded in garments are becoming increasingly common. Such electronics often need connectivity to external devices for power and/or data transmission. For example, it can be difficult to integrate bulky electronic components (e.g., batteries, microprocessors, wireless units, and sensors) into wearable garments, such as a shirt, coat, or pair of pants. Furthermore, connecting such electronic components to a garment may cause issues with durability since garments are often washed.

### SUMMARY

This document describes an interactive object with multiple electronics modules. An interactive object (e.g., a garment) includes a plurality, such as a grid or array, of conductive threads woven into the interactive object, and an internal electronics module coupled to the plurality of conductive threads. The internal electronics module includes a first subset of electronic components, such as sensing circuitry configured to detect touch-input to the conductive threads. An external electronics module that includes a second subset of electronic components (e.g., a microprocessor, power source, or network interface) is removably coupled to the interactive object via a communication interface. The communication interface enables communication between the internal electronics module and the external electronics module when the external electronics module is coupled to the interactive object.

In one embodiment, the present disclosure is particularly directed to the external electronics module. For instance, in one embodiment, the electronics module may comprise a flexible carrier having a first end and a second and opposite end. A first electronic device can be located at the first end and a second electronic device can be located at the second end. In accordance with the present disclosure, a circuit connecting portion electrically connects the first electronic device to the second electronic device. The circuit connecting portion comprises a flexible support contained within the flexible carrier. The flexible support has a planar and serpentine configuration. For instance, the circuit connecting portion can include at least two curved segments, such as at least three curved segments that are located adjacent to each other such that the circuit connecting portion has a winding middle section that zigzags back and forth. In one embodiment, the circuit connecting portion can include a first end section and a second end section on opposite sides of the serpentine middle section. The first end section and the second end section can be linear and can be substantially parallel to each other. As used herein, “substantially parallel” means that the two linear sections are either parallel or skew by no more than 5°, such as by no more than 3°, such as by no more than 2°.

The curved segments of the circuit connecting portion can have a wave height. For instance, the circuit connecting portion can include a first curved segment that has a wave height in one direction and a second curved segment that has a wave height in an opposite direction and wherein the wave height of the first curved segment is the same as the wave height of the second curved segment. In this manner, the curved segments can form a sinusoidal wave. The sinusoidal wave can have equal wave heights when measured along a linear segment that bisects the peaks of two adjacent waves. In accordance with the present disclosure, the serpentine configuration of the circuit connecting portion has been found to provide strain relief and allows the electronics module to be twisted and flexed without damage occurring to the electrical connection between the first electronic device and the second electronic device.

In one embodiment at least one of the curved segments forms an arc or a curve section greater than 120°, in particular greater than 150°, in particular greater than 160°, in particular greater than 170°, in particular 180°. In a further embodiment at least two curved segments having the same arc or curve sections though in different directions. In another embodiment at least one curved segment differs from at least one other curved segment, in particular having an arc or a curve section of less than 180°, in particular less than 170°, in particular less than 160°, but more than 100°, in particular more than 110°, in particular more than 120°, in particular more than 130°, in particular more than 140°,

In one embodiment, the circuit connecting portion comprises a flexible printed circuit board. In one embodiment, the first electronic device can comprise a microprocessor and the second electronic device can comprise a power source. In one embodiment, the electronics module can further include a network interface configured to enable communication with a remote computing device. In addition to a microprocessor and a network interface or instead of a microprocessor and a network interface, the electronics module may include an accelerometer, a heart rate monitor, or a pedometer.

As described above, the electronics module includes a flexible carrier. The flexible carrier may comprise a polymer that has been molded over the circuit connecting portion. The polymer, in one embodiment, may comprise a thermoplastic elastomer or rubber. In an alternative embodiment, the polymer may comprise a thermoplastic polymer, such as a nylon. In still another embodiment, the flexible carrier may comprise a composite fabric.

In one embodiment the internal electronics module further includes a ramp portion that extends from a surface of the interactive object to the plurality of electrical contact pads, the conductive threads being positioned on the ramp portion when extending from the interactive object to the electrical contact pads.

In a further embodiment, the internal electronics module comprises a sensing circuitry, in particular with a self-capacitance sensor and/or a projective capacitance sensor.

This document also describes a system with multiple electronic modules.

The present disclosure is also directed to a system comprising an interactive object. The system includes an external electronics module as described above that is removably coupled to the interactive object. The interactive object, for instance, may comprise a textile product or may comprise various other different articles or products.

The interactive object, for instance, may comprise a wearable garment. In one embodiment, the interactive object may comprise footwear. In one embodiment, the external electronics module may comprise a connector plug that connects to a receptacle on the internal electronics module. The connector plug can be configured to form a snap connection, a magnetic connection, or both a snap connection and a magnetic connection.

This summary is provided to introduce simplified concepts concerning an interactive object with multiple electronics modules, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of an interactive object with multiple electronics modules are described with reference to the following drawings. The same numbers are used throughout the drawings to reference like features and components:

FIG. 1 is an illustration of an example environment in which an interactive textile with multiple electronics modules can be implemented.

FIG. 2 illustrates an example system that includes an interactive object and multiple electronics modules.

FIG. 3 illustrates an example of an interactive object with multiple electronics modules in accordance with one or more implementations.

FIG. 4 illustrates an example of a connector for connecting an external communications module to an interactive object in accordance with one or more implementations.

FIG. 5 illustrates an example of an external electronics module in accordance with one or more implementations.

FIG. 6 illustrates an example of a subassembly for producing an external electronics module in accordance with one or more implementations.

FIG. 7 also illustrates a subassembly that may be used to produce an external electronics module in accordance with one or more implementations.

FIG. 8 illustrates an example of a connector in accordance with one or more implementations.

FIG. 9 illustrates an exploded view of a connector when implemented with an anisotropic conducting polymer in accordance with one or more implementations.

FIG. 10 illustrates various components of an example computing system that can be implemented as any type of client, server, and/or computing device as described with reference to the previous FIGS. 1-9 to implement an interactive object with multiple electronics modules.

### DETAILED DESCRIPTION

### Overview

Electronics embedded in garments and other flexible objects (e.g., blankets, handbags, and hats) are becoming increasingly common. Such electronics often need connectivity to external devices for power and/or data transmission. For example, it can be difficult to integrate bulky electronic components (e.g., batteries, microprocessors, wireless units, and sensors) into wearable garments, such as a shirt, coat, a shoe, or pair of pants. Furthermore, connecting such electronic components to a garment may cause issues with durability since garments are often washed. However, some electronic components, such as sensing circuity, are better equipped to be positioned within the garment.

An interactive object with multiple electronics modules is described. An interactive object (e.g., a garment) includes at least an internal electronics module containing a first subset of electronic components for the interactive object, and an external electronics module containing a second subset of electronic components for the interactive object. As described herein, the internal electronics module may be physically and permanently coupled to the interactive object, whereas the external electronics module may be removably coupled to the interactive object. Thus, instead of integrating all of the electronics within the interactive object, at least some of the electronics are placed in the external electronics module.

In one or more implementations, the interactive object includes an interactive textile with conductive threads woven into the textile to form a flexible touch pad. The internal electronics module contains sensing circuity that is directly coupled to the conductive threads to enable the detection of touch-input to the interactive textile. The external electronics module contains electronic components that are needed to process and communicate the touch-input data, such as a microprocessor, a power source, a network interface, and so forth.

In addition to textile products, the interactive object may comprise various different products and articles. For instance, the external electronics module can be configured to connect to any consumer or industrial product in order to communicate with other electronic devices and/or provide data or other information to a user during interaction with the interactive object.

The interactive object can further include a communication interface configured to enable communication between the internal electronics module and the external electronics module. In some implementations, the communication interface may be implemented as a connector that connects the electronic components in the external electronics module to the electronic components in the internal electronics module to enable the transfer of power and data between the modules. The connector may include a connector plug and a connector receptacle. For example, the connector plug may be implemented at the external electronics module and is configured to connect to the connector receptacle, which may be implemented at the interactive object.

Thus, while the electronic components are separated into multiple different modules, the communication interface enables the system to function as a single unit. For example, the power source contained within the external electronics module may transfer power, via the communication interface, to the sensing circuity of the internal electronics module to enable the sensing circuitry to detect touch-input to the conductive thread. When touch-input is detected by the sensing circuity of the internal electronics module, data representative of the touch-input may be communicated, via the communication interface, to the microprocessor contained within the external electronics module. The microprocessor may then analyze the touch-input data to generate one or more control signals, which may then be communicated to a remote computing device (e.g., a smart phone) via the network interface to cause the computing device to initiate a particular functionality.

Separating the electronics of the interactive object into multiple different modules provides a variety of different benefits. For example, the system design enables interoperability and customization because the external electronics module can be detached from the interactive object, and then attached to a different interactive object to carry over some of the functions and properties, such as user specific settings. Additionally, by separating the garment embedded electronics from the external electronics module, users, designers and companies are able to design the external electronics modules in the form factor, mechanical, material and surface finish qualities that are specific to the application or the user. For example, a leather jacket might have an external electronics module that is leather, and in the form of a strap that matches a certain jacket style, or allows a flexible form factor that would have been hard to achieve inside a garment.

Furthermore, separating the electronics enable broken parts to be easily replaced or serviced without the need to access the entire interactive object. For example, the external electronics module can be shipped to a repair service, or a new external electronics module can be purchased without the need to purchase a new interactive object. In addition, separating the electronic components into internal and external modules ensures that parts such as batteries are not exposes to washing cycles that a typical garment would go through. For example, the external electronics module, which may include the battery, can easily be removed from the interactive object before washing the interactive object. Furthermore, by separating parts, the manufacturing challenges are significantly simplified and certification processes (such as FCC certification for RF transmission units) can be handled over the part in question, thereby reducing the complexity.

### Example Environment

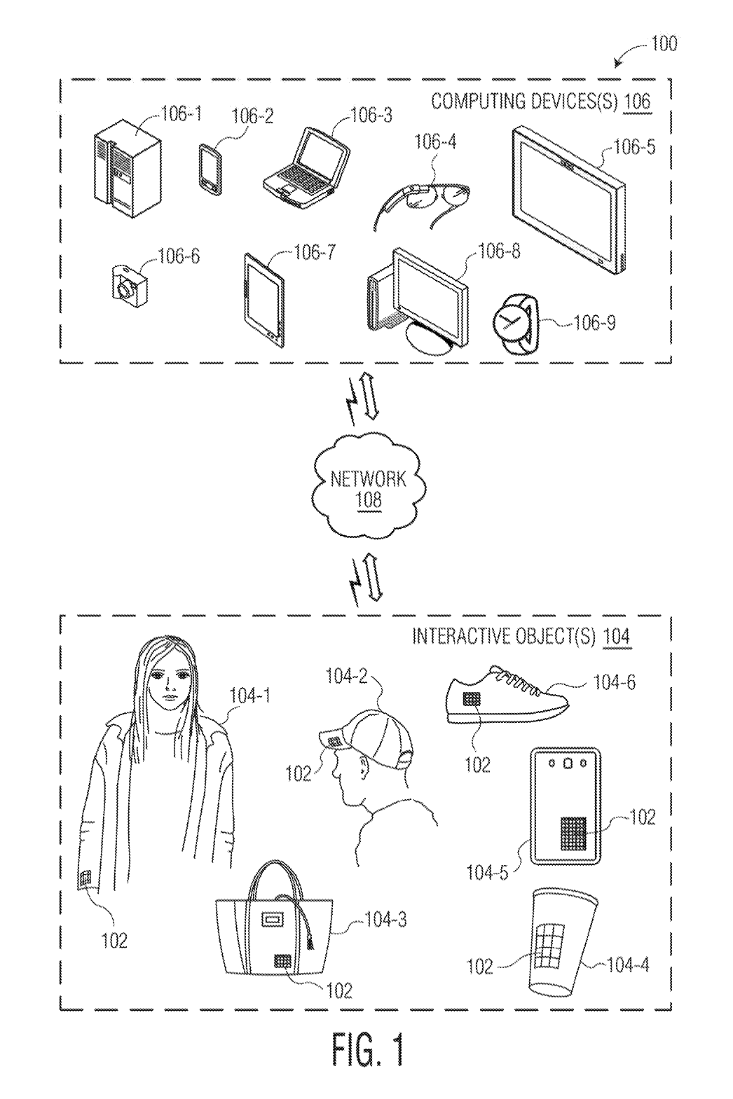

FIG. 1 is an illustration of an example environment 100 in which an interactive textile with multiple electronics modules can be implemented. Environment 100 includes an interactive textile 102, which is shown as being integrated within various interactive objects 104. Interactive textile 102 is a textile that is configured to sense multi-touch-input. As described herein, a textile corresponds to any type of flexible woven material consisting of a network of natural or artificial fibers, often referred to as thread or yarn. Textiles may be formed by weaving, knitting, crocheting, knotting, pressing threads together or consolidating fibers or filaments together in a nonwoven manner.

In environment 100, interactive objects 104 include “flexible” objects, such as a shirt 104-1, a hat 104-2, a handbag 104-3 and a shoe 104-6. It is to be noted, however, that interactive textile 102 may be integrated within any type of flexible object made from fabric or a similar flexible material, such as garments or articles of clothing, blankets, shower curtains, towels, sheets, bed spreads, or fabric casings of furniture, to name just a few. Interactive textile 102 may be integrated within flexible objects 104 in a variety of different ways, including weaving, sewing, gluing, and so forth.

In addition to textile products, electronics modules made in accordance with the present disclosure can also be incorporated into various non-textile products. In general, electronics modules made in accordance with the present disclosure can be incorporated into or used with any suitable object with an interactive element.

For example, objects 104 further include “hard” objects, such as a plastic cup 104-4 and a hard smart phone casing 104-5. It is to be noted, however, that hard objects 104 may include any type of “hard” or “rigid” object made from non-flexible or semi-flexible materials, such as plastic, metal, aluminum, and so on. For example, hard objects 104 may also include plastic chairs, water bottles, plastic balls, or car parts, to name just a few. Interactive textile 102 may be integrated within hard objects 104 using a variety of different manufacturing processes. In one or more implementations, injection molding is used to integrate interactive textiles 102 into hard objects 104.

Interactive textile 102 enables a user to control object 104 that the interactive textile 102 is integrated with, or to control a variety of other computing devices 106 via a network 108. Computing devices 106 are illustrated with various non-limiting example devices: server 106-1, smart phone 106-2, laptop 106-3, computing spectacles 106-4, television 106-5, camera 106-6, tablet 106-7, desktop 106-8, and smart watch 106-9, though other devices may also be used, such as home automation and control systems, sound or entertainment systems, home appliances, security systems, netbooks, and ereaders. Note that computing device 106 can be wearable (e.g., computing spectacles and smart watches), non-wearable but mobile (e.g., laptops and tablets), or relatively immobile (e.g., desktops and servers).

Network 108 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Interactive textile 102 can interact with computing devices 106 by transmitting touch data through network 108. Computing device 106 uses the touch data to control computing device 106 or applications at computing device 106. A s an example, consider that interactive textile 102 integrated at shirt 104-1 may be configured to control the user's smart phone 106-2 in the user's pocket, television 106-5 in the user's home, smart watch 106-9 on the user's wrist, or various other appliances in the user's house, such as thermostats, lights, music, and so forth. For example, the user may be able to swipe up or down on interactive textile 102 integrated within the user's shirt 104-1 to cause the volume on television 106-5 to go up or down, to cause the temperature controlled by a thermostat in the user's house to increase or decrease, or to turn on and off lights in the user's house. Note that any type of touch, tap, swipe, hold, or stroke gesture may be recognized by interactive textile 102.

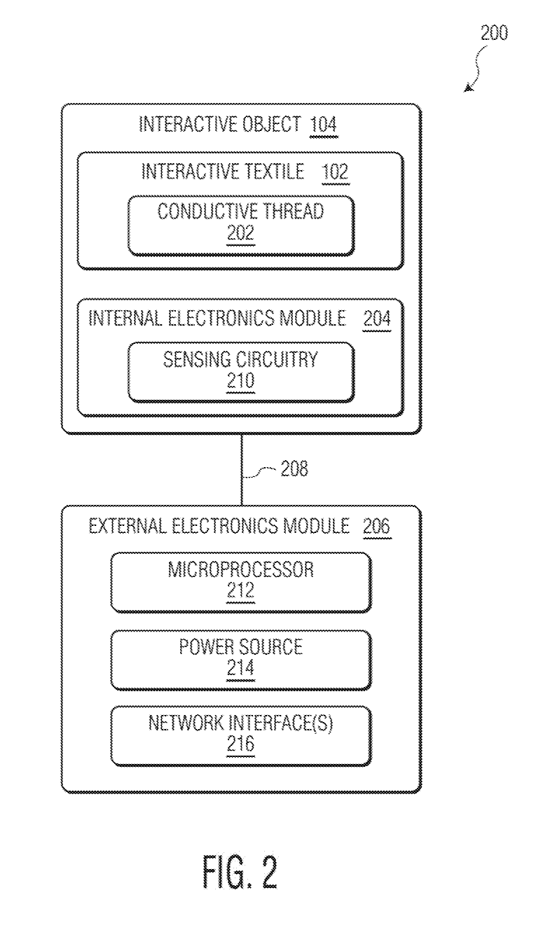

In more detail, consider FIG. 2 which illustrates an example system 200 that includes an interactive object and multiple electronics modules. In system 200, interactive textile 102 is integrated in an object 104, which may be implemented as a flexible object (e.g., shirt 104-1, hat 104-2, or handbag 104-3) or a hard object (e.g., plastic cup 104-4 or smart phone casing 104-5).

Interactive textile 102 is configured to sense multi-touch-input from a user when one or more fingers of the user's hand touch interactive textile 102. Interactive textile 102 may also be configured to sense full-hand touch-input from a user, such as when an entire hand of the user touches or swipes interactive textile 102. To enable the detection of touch-input, interactive textile 102 includes conductive threads 202, which are woven into interactive textile 102 (e.g., in a grid, array or parallel pattern). Notably, the conductive threads 202 do not alter the flexibility of interactive textile 102, which enables interactive textile 102 to be easily integrated within interactive objects 104.

Interactive object 104 includes an internal electronics module 204 that is embedded within interactive object 104 and is directly coupled to conductive threads 202. Internal electronics module 204 can be communicatively coupled to an external electronics module 206 via a communication interface 208. Internal electronics module 204 contains a first subset of electronic components for the interactive object 104, and external electronics module 206 contains a second, different, subset of electronics components for the interactive object 104. As described herein, the internal electronics module 204 may be physically and permanently embedded within interactive object 104, whereas the external electronics module 206 may be removably coupled to interactive object 104.

In system 200, the electronic components contained within the internal electronics module 204 includes sensing circuity 210 that is coupled to conductive thread 202 that is woven into interactive textile 102. For example, wires from the conductive threads 202 may be connected to sensing circuitry 210 using flexible PCB, creping, gluing with conductive glue, soldering, and so forth. In one embodiment, the sensing circuitry 210 can be configured to detect a user-inputted touch-input on the conductive threads that is pre-programmed to indicate a certain request. In one embodiment, when the conductive threads form a grid or other pattern, sensing circuitry 210 can be configured to also detect the location of the touch-input on conductive thread 202, as well as motion of the touch-input. For example, when an object, such as a user's finger, touches conductive thread 202, the position of the touch can be determined by sensing circuitry 210 by detecting a change in capacitance on the grid or array of conductive thread 202. The touch-input may then be used to generate touch data usable to control computing device 106. For example, the touch-input can be used to determine various gestures, such as single-finger touches (e.g., touches, taps, and holds), multi-finger touches (e.g., two-finger touches, two-finger taps, two-finger holds, and pinches), single-finger and multi-finger swipes (e.g., swipe up, swipe down, swipe left, swipe right), and full-hand interactions (e.g., touching the textile with a user's entire hand, covering textile with the user's entire hand, pressing the textile with the user's entire hand, palm touches, and rolling, twisting, or rotating the user's hand while touching the textile).

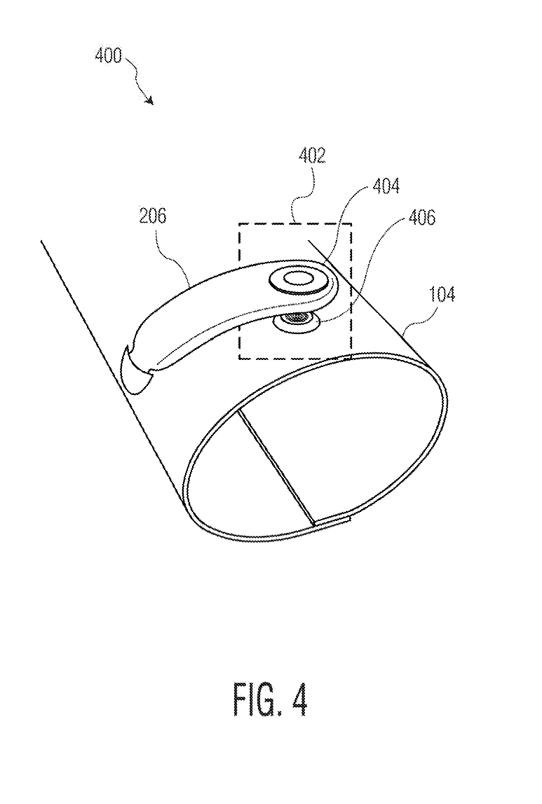

Communication interface 208 enables the transfer of power and data (e.g., the touch-input detected by sensing circuity 210) between the internal electronics module 204 and the external electronics module 206. In some implementations, communication interface 208 may be implemented as a connector that includes a connector plug and a connector receptacle. The connector plug may be implemented at the external electronics module 206 and is configured to connect to the connector receptacle, which may be implemented at the interactive object 104. A more-detailed discussion of example connectors is discussed below with regards to FIGS. 4 and 8-9.

In system 200, the external electronics module 206 includes a microprocessor 212, power source 214, and network interface 216. Power source 214 may be coupled, via communication interface 208, to sensing circuitry 210 to provide power to sensing circuitry 210 to enable the detection of touch-input, and may be implemented as a small battery. When touch-input is detected by sensing circuity 210 of the internal electronics module 204, data representative of the touch-input may be communicated, via communication interface 208, to microprocessor 212 of the external electronics module 206. Microprocessor 212 may then analyze the touch-input data to generate one or more control signals, which may then be communicated to computing device 106 (e.g., a smart phone) via the network interface 216 to cause the computing device 106 to initiate a particular functionality. Generally, network interfaces 216 are configured to communicate data, such as touch data, over wired, wireless, or optical networks to computing devices 106. By way of example and not limitation, network interfaces 216 may communicate data over a local-area-network (LAN), a wireless local-area-network (WLAN), a personal-area-network (PAN) (e.g., Bluetooth™), a wide-area-network (WAN), an intranet, the Internet, a peer-to-peer network, point-to-point network, a mesh network, and the like (e.g., through network 108 of FIG. 1).

While internal electronics module 204 and external electronics module 206 are illustrated and described as including specific electronic components, it is to be appreciated that these modules may be configured in a variety of different ways. For example, in some cases, electronic components described as being contained within internal electronics module 204 may be at least partially implemented at the external electronics module 206, and vice versa. Furthermore, internal electronics module 204 and external electronics module 206 may include electronic components other that those illustrated in FIG. 2, such as sensors, light sources (e.g., LED's), displays, speakers, and so forth.

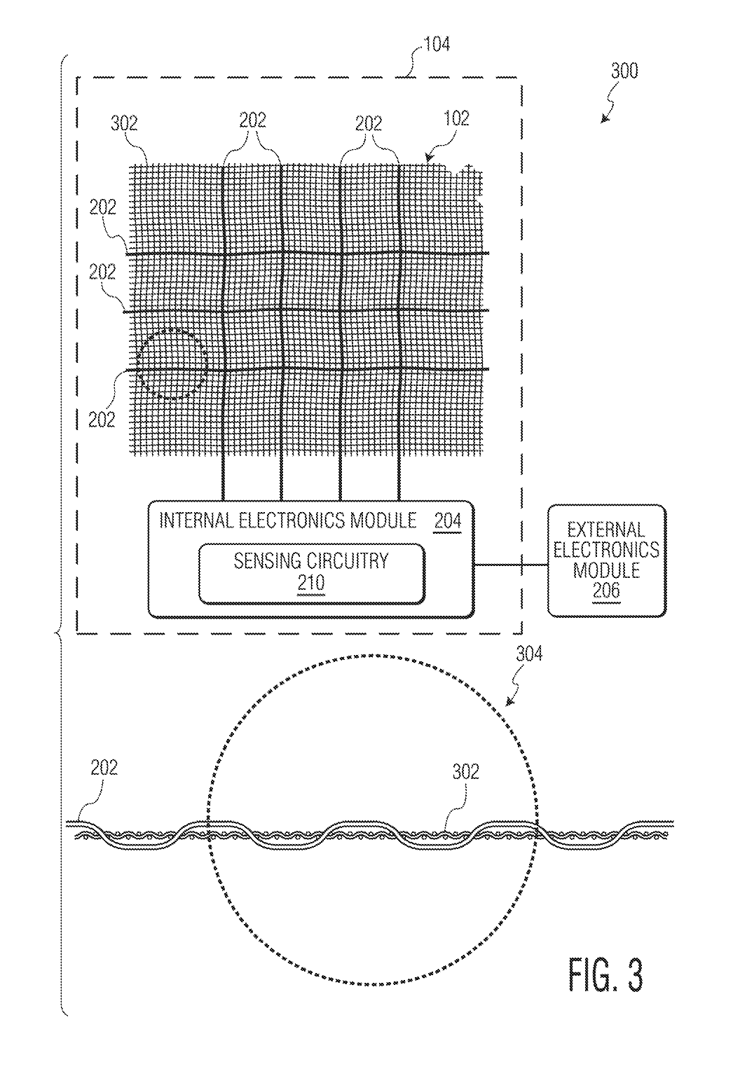

FIG. 3 illustrates an example 300 of interactive object 104 with multiple electronics modules in accordance with one or more implementations. In this example, interactive textile 102 of the interactive object 104 includes non-conductive threads 302 woven with conductive threads 202 to form interactive textile 102. Non-conductive threads 302 may correspond to any type of non-conductive thread, fiber, or fabric, such as cotton, wool, silk, nylon, polyester, and so forth.

At 304, a zoomed-in view of conductive thread 202 is illustrated. Conductive thread 202 includes a conductive wire or a plurality of conductive filaments that are twisted, braided, or wrapped with a flexible thread. As shown, the conductive thread 202 can be woven or otherwise integrated with the non-conductive threads 302 to form a fabric or a textile.

In one or more implementations, conductive thread 202 includes a thin copper wire. It is to be noted, however, that the conductive thread 202 may also be implemented using other materials, such as silver, gold, or other materials coated with a conductive polymer. The conductive thread 202 may include an outer cover layer formed by braiding together non-conductive threads. The non-conductive threads may be implemented as any type of flexible thread or fiber, such as cotton, wool, silk, nylon, polyester, and so forth.

Interactive textile 102 can be formed cheaply and efficiently, using any conventional weaving process (e.g., jacquard weaving or 3D-weaving), which involves interlacing a set of longer threads (called the warp) with a set of crossing threads (called the weft). Weaving may be implemented on a frame or machine known as a loom, of which there are a number of types. Thus, a loom can weave non-conductive threads 302 with conductive threads 202 to create interactive textile 102.

The conductive threads 202 can be woven into the textile 102 in any suitable pattern or array. In one embodiment, for instance, the conductive threads 202 may form a single series of parallel threads. For instance, in one embodiment, the capacitive touch sensor may comprise a single plurality of parallel conductive threads conveniently located on the interactive object, such as on the sleeve of a jacket.

In an alternative embodiment, the conductive threads 202 may form a grid as shown in FIG. 3.

In example 300, conductive thread 202 is woven into interactive textile 102 to form a grid that includes a set of substantially parallel conductive threads 202 and a second set of substantially parallel conductive threads 202 that crosses the first set of conductive threads to form the grid. In this example, the first set of conductive threads 202 are oriented horizontally and the second set of conductive threads 202 are oriented vertically, such that the first set of conductive threads 202 are positioned substantially orthogonal to the second set of conductive threads 202. It is to be appreciated, however, that conductive threads 202 may be oriented such that crossing conductive threads 202 are not orthogonal to each other. For example, in some cases crossing conductive threads 202 may form a diamond-shaped grid. While conductive threads 202 are illustrated as being spaced out from each other in FIG. 3, it is to be noted that conductive threads 202 may be weaved very closely together. For example, in some cases two or three conductive threads may be weaved closely together in each direction. Further, in some cases the conductive threads may be oriented as parallel sensing lines that do not cross or intersect with each other.

In example 300, sensing circuity 210 is shown as being integrated within object 104, and is directly connected to conductive threads 202. During operation, sensing circuitry 210 can determine positions of touch-input on the grid of conductive thread 202 using self-capacitance sensing or projective capacitive sensing.

For example, when configured as a self-capacitance sensor, sensing circuitry 210 charges crossing conductive threads 202 (e.g., horizontal and vertical conductive threads) by applying a control signal (e.g., a sine signal) to each conductive thread 202. When an object, such as the user's finger, touches the grid of conductive thread 202, the conductive threads 202 that are touched are grounded, which changes the capacitance (e.g., increases or decreases the capacitance) on the touched conductive threads 202.

Sensing circuitry 210 uses the change in capacitance to identify the presence of the object. To do so, sensing circuitry 210 detects a position of the touch-input by detecting which horizontal conductive thread 202 is touched, and which vertical conductive thread 202 is touched by detecting changes in capacitance of each respective conductive thread 202. Sensing circuitry 210 uses the intersection of the crossing conductive threads 202 that are touched to determine the position of the touch-input on the grid of conductive threads 202. For example, sensing circuitry 210 can determine touch data by determining the position of each touch as X,Y coordinates on the grid of conductive thread 202.

When implemented as a self-capacitance sensor, “ghosting” may occur when multi-touch-input is received. Consider, for example, that a user touches the grid of conductive thread 202 with two fingers. When this occurs, sensing circuitry 210 determines X and Y coordinates for each of the two touches. However, sensing circuitry 210 may be unable to determine how to match each X coordinate to its corresponding Y coordinate. For example, if a first touch has the coordinates X1, Y1 and a second touch has the coordinates X4, Y4, sensing circuitry 210 may also detect “ghost” coordinates X1, Y4 and X4, Y1.

In one or more implementations, sensing circuitry 210 is configured to detect “areas” of touch-input corresponding to two or more touch-input points on the grid of conductive thread 202. Conductive threads 202 may be weaved closely together such that when an object touches the grid of conductive thread 202, the capacitance will be changed for multiple horizontal conductive threads 202 and/or multiple vertical conductive threads 202. For example, a single touch with a single finger may generate the coordinates X1, Y1 and X2, Y1. Thus, sensing circuitry 210 may be configured to detect touch-input if the capacitance is changed for multiple horizontal conductive threads 202 and/or multiple vertical conductive threads 202. Note that this removes the effect of ghosting because sensing circuitry 210 will not detect touch-input if two single-point touches are detected which are spaced apart.

Alternately, when implemented as a projective capacitance sensor, sensing circuitry 210 charges a single set of conductive threads 202 (e.g., horizontal conductive threads 202) by applying a control signal (e.g., a sine signal) to the single set of conductive threads 202. Then, sensing circuitry 210 senses changes in capacitance in the other set of conductive threads 202 (e.g., vertical conductive threads 202).

In this implementation, vertical conductive threads 202 are not charged and thus act as a virtual ground. However, when horizontal conductive threads 202 are charged, the horizontal conductive threads capacitively couple to vertical conductive threads 202. Thus, when an object, such as the user's finger, touches the grid of conductive thread 202, the capacitance changes on the vertical conductive threads (e.g., increases or decreases). Sensing circuitry 210 uses the change in capacitance on vertical conductive threads 202 to identify the presence of the object. To do so, sensing circuitry 210 detects a position of the touch-input by scanning vertical conductive threads 202 to detect changes in capacitance. Sensing circuitry 210 determines the position of the touch-input as the intersection point between the vertical conductive thread 202 with the changed capacitance, and the horizontal conductive thread 202 on which the control signal was transmitted. For example, sensing circuitry 210 can determine touch data by determining the position of each touch as X,Y coordinates on the grid of conductive thread 202.

Whether implemented as a self-capacitance sensor or a projective capacitance sensor, the conductive thread 202 and sensing circuitry 210 is configured to communicate the touch data that is representative of the detected touch-input to external electronics module 206, which is removably coupled to interactive object 104 via communication interface 208. The microprocessor 212 may then cause communication of the touch data, via network interface 216, to computing device 106 to enable the device to determine gestures based on the touch data, which can be used to control object 104, computing device 106, or applications implemented at computing device 106.

The computing device 106 can be implemented to recognize a variety of different types of gestures, such as touches, taps, swipes, holds, and covers made to interactive textile 102. To recognize the various different types of gestures, the computing device can be configured to determine a duration of the touch, swipe, or hold (e.g., one second or two seconds), a number of the touches, swipes, or holds (e.g., a single tap, a double tap, or a triple tap), a number of fingers of the touch, swipe, or hold (e.g., a one finger-touch or swipe, a two-finger touch or swipe, or a three-finger touch or swipe), a frequency of the touch, and a dynamic direction of a touch or swipe (e.g., up, down, left, right). With regards to holds, the computing device 106 can also determine an area of the grid of conductive thread 202 that is being held (e.g., top, bottom, left, right, or top and bottom. Thus, the computing device 106 can recognize a variety of different types of holds, such as a cover, a cover and hold, a five finger hold, a five finger cover and hold, a three finger pinch and hold, and so forth.

In one or more implementations, communication interface 208 is implemented as a connector that is configured to connect external electronics module 206 to internal electronics module 204 of interactive object 104. Consider, for example, FIG. 4 which illustrates an example 400 of a connector for connecting an external communications module to an interactive object in accordance with one or more implementations. In example 400, interactive object 104 is illustrated as a jacket.

As described above, interactive object 104 includes an internal electronics module 204 which include various types of electronics, such as sensing circuitry 210, sensors (e.g., capacitive touch sensors woven into the garment, microphones, or accelerometers), output devices (e.g., LEDs, speakers, or micro-displays), electrical circuitry, and so forth.

External electronics module 206 includes various electronics that are configured to connect and/or interface with the electronics of internal electronics module 204. Generally, the electronics contained within external electronics module 206 are different or complementary to those contained within internal electronics module 204, and may include electronics such as microprocessor 212, power source 214 (e.g., a battery), network interface 216 (e.g., Bluetooth or WiFi), output devices (e.g., speakers, LEDs), and so forth. The electronics module 206 may also include various sensors or can include controllers or microprocessors that can communicate with sensors contained in the interactive object.

In this example, external electronics module 206 is implemented as a strap that contains the various electronics. The strap, for example, can be formed from a material such as rubber, nylon, or any other type of fabric. Notably, however, external electronics module 206 may take any type of form. For example, rather than being a strap, external electronics module 206 could resemble a circular or square piece of material (e.g., rubber or nylon).

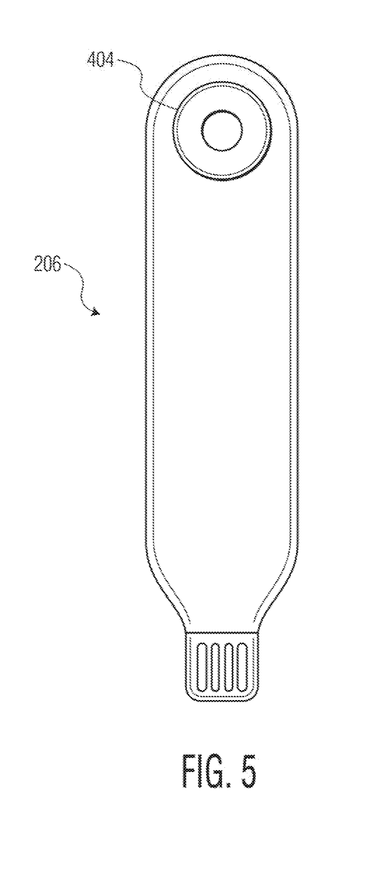

Referring now to FIGS. 5-7, one embodiment of an external electronics module 206 that may be used in accordance with the present disclosure is shown. Ideally, the external electronics module 206 should be very flexible and should be capable of being bended. For instance, depending upon the interactive textile to which the electronics module 206 is connected, the external electronics module 206, in one embodiment, can be very flexible so that the module will conform to the body of the wearer and/or to the interactive textile. In this regard, the embodiment of the external electronics module 206 as shown in FIG. 5 is designed to be very flexible and capable of withstanding substantial bending and flexing without harming the interior electronics.

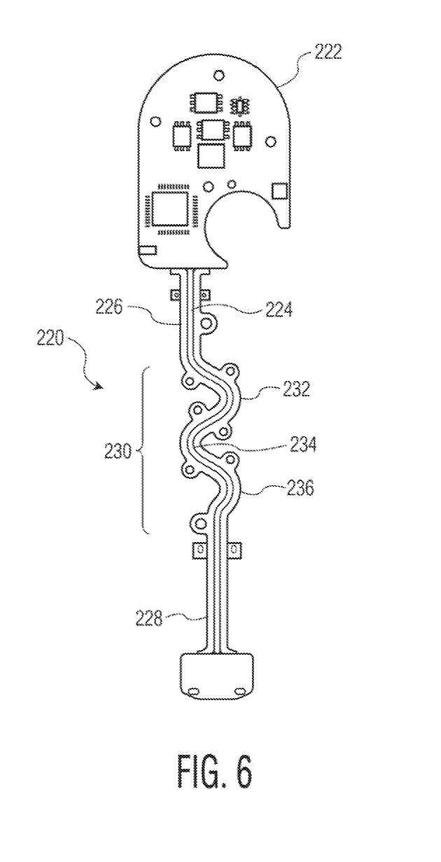

For instance, referring to FIG. 6, a subassembly 220 of the external electronics module 206 is shown. The subassembly 220 includes a first electronic device 222 positioned at a first end of the subassembly 220. In one embodiment, for instance, the first electronics device 222 may comprise a sensor, a microprocessor, a network interface, and combinations thereof. For example, in one embodiment, the first electronic device 222 may be configured to receive signals from the internal electronics module 204 and not only process the signal but communicate wirelessly to another device, such as a mobile phone as described above with respect to FIG. 2. In addition, the first electronic device 222 may include sensors, light sources such as LEDs, displays, speakers, and so forth. Sensors that may be built into the electronic device 222 include, for instance, an accelerometer, a heartbeat monitor, a pedometer, and the like.

As shown in FIG. 6, the first electronic device 222 is in electrical communication with a circuit connecting portion 224. The circuit connecting portion 224 electrically connects the first electronic device to a second and opposite end of the subassembly 220. The circuit connecting portion 224 generally comprises, in one embodiment, a flexible support having a planar and serpentine configuration. In one embodiment, for instance, the circuit connecting portion 224 may comprise a flexible printed circuit board that allows the first end of the external electronics module 206 to communicate with a second and opposite end.

By having a serpentine configuration, the circuit connecting portion 224 offers various advantages and benefits. The serpentine configuration, for instance, provides strain relief and allows the external electronics module 206 to bend and flex without causing a break to occur in the electrical circuitry.

One embodiment of a serpentine configuration of the circuit connecting portion is illustrated in FIG. 6. It should be understood, however, that various other configurations can be used as long as the configurations provide strain relief. In the embodiment illustrated in FIG. 6, for instance, the circuit connecting portion 224 includes a first end section 226, a second end section 228, and a middle section 230 positioned in between the first end section 226 and the second end section 228. The middle section 230 includes a plurality of curved segments that form the serpentine configuration. In the embodiment illustrated in FIG. 6, for instance, the middle section 230 includes a first curved segment 232, a second curved segment 234, and a third curved segment 236. The curved segments 232, 234, and 236 form a zigzag-like strip. In other words, the curved segments alternate between right and left turns or bends.

The first curved segment 232 and the second curved segment 234 generally form an arc or curve section of greater than about 120°, such as greater than about 150°, such as greater than about 160°, such as greater than about 170°. In one embodiment, for instance, the first curved segment 232 and the second curved segment 234 each have an arc of about 180°. For instance, as shown in FIG. 6, the first curved segment 232 and the second curved segment 234 each begin and end along a line that is parallel to the first end section 226 or along a vertical line that extends from the first end to the second end of the subassembly 220.

In this manner, the first curved segment 232 has a wave height in one direction and the second curved segment 234 has a wave height in a second and opposite direction and wherein the wave height of the first curved segment is the same as the wave height of the second curved segment.

The third curved segment 236 can be identical to the first curved segment 232. In the embodiment illustrated in FIG. 6, however, the third curved segment 236 has an arc that is less than 180°. The arc of the third curved segment 236, for instance, is greater than about 100°, such as greater than about 110°, such as greater than about 120°, such as greater than about 130°, such as greater than about 140° but less than about 180°, such as less than about 170°, such as less than about 160°.

The middle section 230 of the circuit connecting portion 224 is also planar meaning that all of the curved segments reside in a single plane. This configuration allows the circuit connecting portion 224 to bend and to twist without causing the printed circuit board to kink or otherwise become damaged.

In the embodiment illustrated in FIG. 6, the circuit connecting portion 224 includes a linear first end section 226 and a linear second end section 228. In one embodiment, the first end section 226 and the second end section 228 can be located along a common line. Alternatively, such as shown in FIG. 6, the first end section 226 can be substantially parallel to the second end section 228.

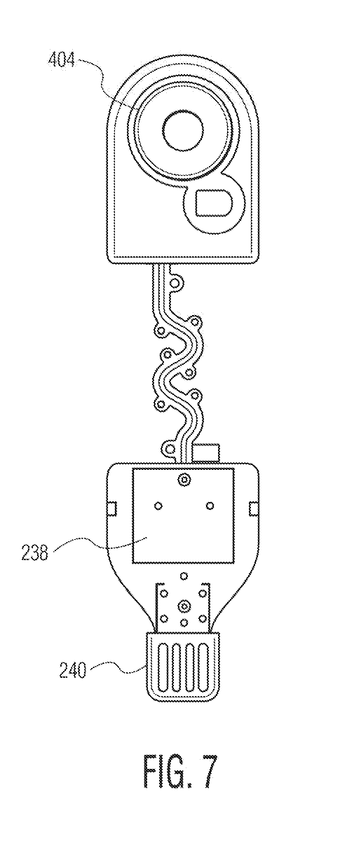

Referring to FIG. 7, the next step in producing the external electronics module 206 is to attach to the second end of the circuit connecting portion 224 a second electronic device 238 and optionally a universal series bus (USB) connector 240. The second electronic device 238, for instance, may comprise a microprocessor, a power source, a network interface, a sensor, or an output device as described above. In one particular embodiment, for instance, the second electrical device 238 comprises a power source.

As shown in FIG. 7, the second end of the external electronics module 206 may also include a USB connector 240. The USB connector 240 can be used to charge a power source contained within the module. The USB connector 240 can also be used to connect the external electronics module 206 to a computer or other device in order to download and/or upload information, in order to download computer software or computer software applications, and the like.

As also shown in FIG. 7, the first electronic device 222, such as a printed circuit board, has been overmolded with a plastic or polymer composition. For example, as shown in FIG. 5, the subassembly illustrated in FIG. 7 has been overmolded with a polymer. For instance, the polymer can be molded over the circuit connecting portion 224 and/or over the first electronic device 222 and the second electronic device 238. The polymer used to cover the circuit connecting portion 224 can comprise, in one embodiment, a thermoplastic elastomer or a rubber. In other embodiments, the polymer used to overmold the circuit connecting portion 224 may be a thermoplastic polymer that has sufficient flexibility, such as a polyamide, a polyolefin, or the like. In one embodiment, the polymer comprises a polyester elastomer or a polyurethane elastomer. As shown in FIGS. 5 and 7, a connector plug 404 is also assembled and integrated into the external electronics module 206. The connector plug 404 is described in greater detail below.

Referring to FIGS. 4, 8 and 9, connector 402 includes the connector plug 404 and a connector receptacle 406. In this example, connector plug 404 is positioned on external electronics module 206 and is configured to attach to connector receptacle 406, which is positioned on interactive object 104, to form an electronic connection between external electronics module 206 and interactive object 104. For example, in FIG. 4, connector receptacle 406 is positioned on a sleeve of interactive object 104, which is illustrated as a jacket. In one embodiment, as shown in FIG. 4, the jacket can include a small pocket or opening that can receive the second end of the external electronics module 206.

In various implementations, connector plug 404 may resemble a snap or button, and is configured to connect or attach to connector receptacle 406 via a magnetic and/or mechanical coupling. For example, in some implementations magnets on connector plug 404 and connector receptacle 406 cause a magnetic connection to form between connector plug 404 and connector receptacle 406. Alternately, a mechanical connection between these two components may cause the components to form a mechanical coupling, such as by “snapping” together.

Connector 402 may be implemented in a variety of different ways. In one or more implementations, connector plug 404 includes an anisotropic conducting polymer which is configured to connect to circular pads of a printed circuit board (PCB) implemented at connector receptacle 406. In another implementation, connector plug 404 may include compliant polyurethane polymers to provide compliance to metal pads implemented at connector receptacle 406 to enable an electromagnetic connection. In another implementation, connector plug 404 and connector receptacle 406 may each include magnetically coupled coils which can be aligned to provide power and data transmission.

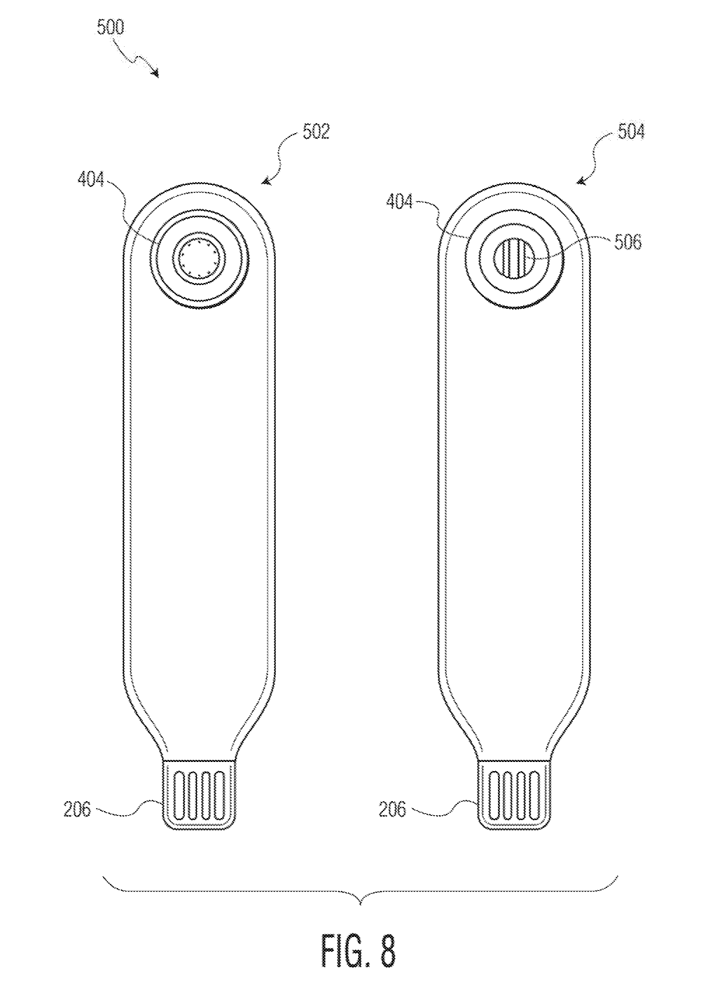

FIG. 8 illustrates an example 500 of connector 402 when implemented with an anisotropic conducting polymer in accordance with one or more implementations.

At 502, a top side of connector plug 404 is shown. In this case, the top side of connector plug 404 resembles a round, button-like structure. Notably the top side of connector plug 404 may be implemented with various different shapes (e.g., square or triangular). Further, in some cases the top side of connector plug 404 may resemble something other than a button or snap.

In this example, the top side of connector plug 404 includes tiny holes that enables light from light sources (e.g., LEDs) to shine through. Of course, other types of input or output units could also be positioned here, such as a microphone or a speaker.

At 504, a bottom side of connector plug 404 is shown. The bottom side of connector plug 404 includes an anisotropic conducting polymer 506 to enable electrical connections between the electronics of interactive object 104 and the electronics of external electronics module 206.

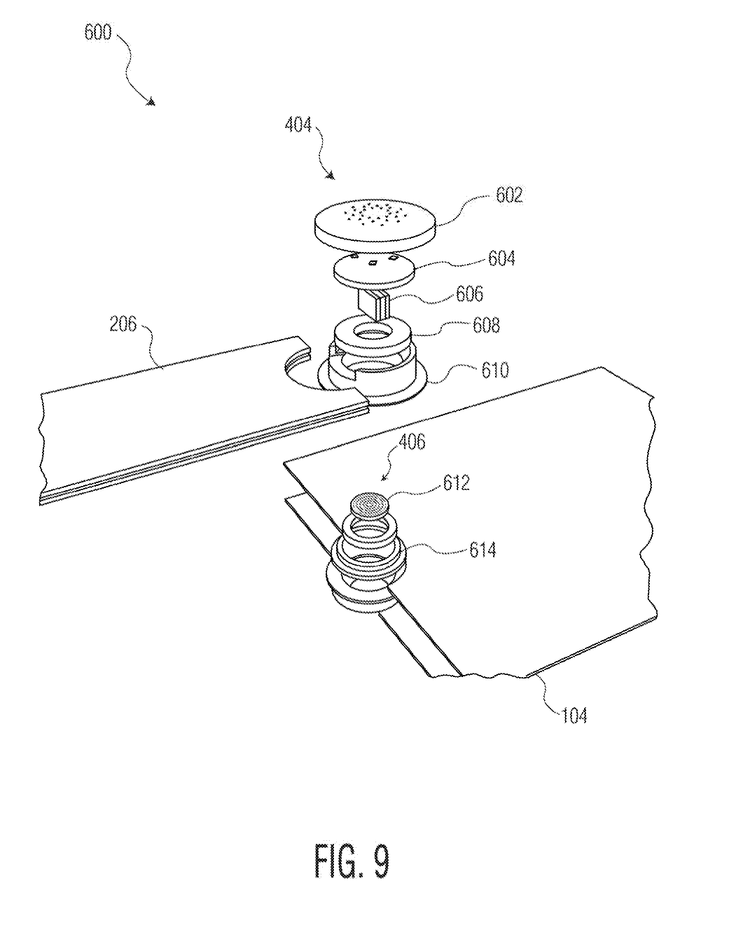

In more detail, consider FIG. 9 which illustrates an exploded view 600 of connector 402 when implemented with an anisotropic conducting polymer in accordance with one or more implementations.

In this example, connector plug 404 of connector 402 includes a button cap 602, a printed circuit board (PCB) 604, anisotropic conducting polymer 606, a magnet 608, and a casing 610.

Button cap 602 resembles a typical button, and may be made from a variety of different materials, such as plastic, metal, and so forth. In this example, button cap 602 includes holes which enable light from LEDs to shine through.

PCB 604 is configured to electrically connect electronics of interactive object 104 to anisotropic conducting polymer 606. A top layer of PCB 604 may include the LEDs that shine through the holes in button cap 602. A bottom layer of PCB 604 includes contacts which electrically connect to anisotropic conducting polymer 606 positioned beneath PCB 604.

Anisotropic conducting polymer 606 includes a strip of anisotropic material that is configured to form a connection with connector receptacle 406. The anisotropic material include any type of anisotropic material.

Magnet 608 is configured to enable a magnetic connection to connector receptacle 406. The magnetic connection enables connector plug 404 to attach to connector receptacle 406 without the need to apply force to connect, which reduces the chance of the connection wearing down over time. Alternately, in one or more implementations, connector plug 404 may be implemented without magnet 608. For example, connector plug 404 could be implemented as physical or mechanical snap that snaps to connector receptacle 406. Casing 610 is configured to hold the components of connector plug 404, and can be implemented from a variety of different materials such as plastic, metal, and so forth.

In this example, connector receptacle 406 includes a receptacle PCB 612 which includes circular pads which are configured to connect to anisotropic conducting polymer 606. The bottom layer of receptacle PCB 612 includes connections to the electronics of interactive object 104.

Connector receptacle may also include a metallic component 614 which is configured to generate a magnetic force with magnet 608 of connector plug 404 to form the magnetic connection between connector plug 404 and connector receptacle 406. Metallic component 614 may be implemented as any type of metal or alloy, or as another magnet, that can generate a magnetic force with magnet 608. Connector receptacle 406 may also include other components, such as a housing, a washer, and so forth.

Notably, anisotropic conducting polymer 606 includes various properties which make for a good connector, which include rotational tolerance, mechanical compliance, multi-pin electrical and power transmission, and being waterproof.

For instance, when connector plug 404 attaches to connector receptacle 406, an electrical connection is formed between anisotropic conducting polymer 606 and receptacle PCB 612. The anisotropic conducting polymer 606 provides rotational tolerance because the strip of anisotropic material can be rotated 360 degrees and maintain the same connection to the circular pads of receptacle PCB 612. This is beneficial because when wearing a garment, the strap of external electronics module 206 will naturally move around. Thus, the rotational tolerance enables the connector to be rotated without losing the connection between connector plug 404 and connector receptacle 406. Furthermore, the anisotropic conducting polymer 606 is elastomeric, which causes the strip of material to shrink and conform under mechanical force.

Anisotropic conducting polymer 606 provides multi-pin electrical transmissions and power transfer transmissions simultaneously. For example, the anisotropic material causes conduction to occur in just one direction, which means that the conductive paths can operate completely independently, without interfering with each other. This enables multiple conducting channels, which makes it easy to isolate multiple data lines or power lines from each other using anisotropic conducting polymer 606 and the circular structure of receptacle PCB 612.

Additionally, anisotropic conducting polymer 606 is waterproof which prevents connector 402 from being damaged by water, such as when being worn in the rain or when being washed.

Connector 402 may be implemented in a variety of different ways. In one or more implementations, instead of using anisotropic conducting polymer 606, connector plug 404 may include compliant polyurethane polymers to provide compliance to metal pads implemented at connector receptacle 406 to enable an electromagnetic connection. In another implementation, connector plug 404 and connector receptacle 406 may each include magnetically coupled coils which can be aligned to provide power and data transmission between interactive object 104 and external electronics module 206.

### Example Computing System

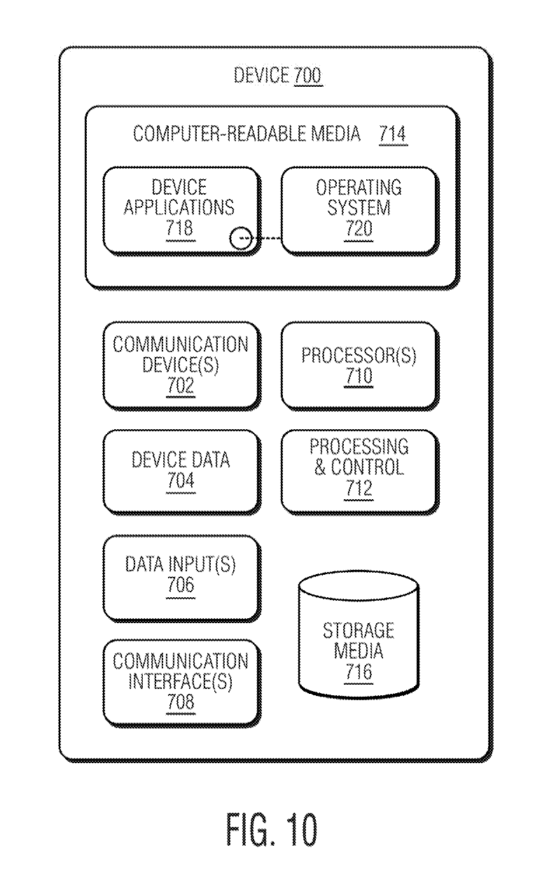

FIG. 10 illustrates various components of an example computing system 700 that can be implemented as any type of client, server, and/or computing device as described with reference to the previous FIGS. 1-9 to implement an interactive object with multiple electronics modules. For example, computing system 700 may correspond to external electronics module 206 and/or embedded in interactive object 104. In embodiments, computing system 700 can be implemented as one or a combination of a wired and/or wireless wearable device, System-on-Chip (SoC), and/or as another type of device or portion thereof. Computing system 700 may also be associated with a user (e.g., a person) and/or an entity that operates the device such that a device describes logical devices that include users, software, firmware, and/or a combination of devices.

Computing system 700 includes communication devices 702 that enable wired and/or wireless communication of device data 704 (e.g., received data, data that is being received, data scheduled for broadcast, data packets of the data, etc.). Device data 704 or other device content can include configuration settings of the device, media content stored on the device, and/or information associated with a user of the device. Media content stored on computing system 700 can include any type of audio, video, and/or image data. Computing system 700 includes one or more data inputs 706 via which any type of data, media content, and/or inputs can be received, such as human utterances, userselectable inputs (explicit or implicit), messages, music, television media content, recorded video content, and any other type of audio, video, and/or image data received from any content and/or data source.

Computing system 700 also includes communication interfaces 708, which can be implemented as any one or more of a serial and/or parallel interface, a wireless interface, any type of network interface, a modem, and as any other type of communication interface. Communication interfaces 708 provide a connection and/or communication links between computing system 700 and a communication network by which other electronic, computing, and communication devices communicate data with computing system 700.

Computing system 700 includes one or more processors 710 (e.g., any of microprocessors, controllers, and the like), which process various computer-executable instructions to control the operation of computing system 700 and to enable techniques for, or in which can be embodied, interactive textiles. Alternatively or in addition, computing system 700 can be implemented with any one or combination of hardware, firmware, or fixed logic circuitry that is implemented in connection with processing and control circuits which are generally identified at 712. Although not shown, computing system 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Computing system 700 also includes computer-readable media 714, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computing system 700 can also include a mass storage media device 716.

Computer-readable media 714 provides data storage mechanisms to store device data 704, as well as various device applications 718 and any other types of information and/or data related to operational aspects of computing system 700. For example, an operating system 720 can be maintained as a computer application with computer-readable media 714 and executed on processors 710. Device applications 718 may include a device manager, such as any form of a control application, software application, signal-processing and control module, code that is native to a particular device, a hardware abstraction layer for a particular device, and so on. Device applications 718 also include any system components, engines, or managers to implement an interactive object with multiple electronics modules.

### CONCLUSION

Although embodiments of techniques using, and objects including, an interactive object with multiple electronics modules has been described in language specific to features and/or methods, it is to be understood that the subject of the appended claims is not necessarily limited to the specific features or methods described. Rather, the specific features and methods are disclosed as example implementations of an interactive object with multiple electronics modules.

What is claimed is:

1. An electronics module comprising:
a flexible carrier having a first end and a second and opposite end;
a first electronic device located at the first end;
a second electronic device located at the second end; and
a circuit connecting portion electrically connecting the first electronic device to the second electronic device, the circuit connecting portion comprising a flexible support contained within the flexible carrier, the flexible support having a planar and serpentine configuration.

2. An electronics module as defined in claim 1, wherein the circuit connecting portion includes a first end section connected to the first electrical device and a second end section connected to the second electrical device, the circuit connecting portion further including a middle section that includes a series of alternating curved segments, the first end section and the second end section being linear.

3. An electronics module as defined in claim 2, wherein the circuit connecting portion includes at least two curved segments.

4. An electronics module as defined in claim 2, wherein the first end section is substantially parallel to the second end section.

5. An electronics module as defined in claim 3, wherein the first curved segment has a wave height in one direction and the second curved segment has a wave height in an opposite direction and wherein the wave height of the first curved segment is the same as the wave height of the second curved segment.

6. An electronics module as defined in claim 2, wherein at least one of the curved segments forms an arc or a curve section greater than 120°.

7. An electronics module as defined in claim 2, wherein at least two curved segments having the same arc or curve sections though in different directions.

8. An electronics module as defined in claim 2, wherein at least one curved segment differs from at least one other curved segment, in particular having an arc or a curve section of less than 180°, but more than 100°.

9. An electronics module as defined in claim 1, wherein the circuit connecting portion comprises a flexible printed circuit board.

10. An electronics module as defined in claim 1, wherein the first electronic device comprises a microprocessor and the second electronic device comprises a power source.

11. An electronics module as defined in claim 10, wherein the module further comprises a network interface configured to enable communication with a remote computing device.

12. An electronics module as defined in claim 1, wherein the first electronic device comprises an accelerometer, a heart rate monitor, or a pedometer.

13. An electronics module as defined in claim 1, wherein the flexible carrier comprises a polymer that has been molded over the circuit connecting portion.

14. An electronics module as defined in claim 13, wherein the polymer comprises a thermoplastic elastomer or a rubber.

15. An electronics module as defined in claim 13, wherein the polymer comprises a nylon.

16. An electronics module as defined in claim 1, wherein the flexible carrier comprises a composite fabric.

17. An electronics module as defined in claim 1, wherein the first electronic device comprises a rigid printed circuit board.

18. An electronics module as defined in claim 1, wherein the second electronic device comprises a universal series bus connector.

19. An interactive object as defined in claim 1, wherein the internal electronics module comprises a sensing circuitry with a self-capacitance sensor and/or a projective capacitance sensor.

20. A system comprising:
an interactive object comprising:
an interactive element integrated into the interactive object;
an internal electronics module coupled to the interactive element; and
an electronics module as defined in claim 1 that is removably coupled to the interactive object for communicating with the internal electronics module.

21. A system as defined in claim 20, wherein the interactive object comprises a wearable garment.

22. A system as defined in claim 20, wherein the interactive object comprises footwear.

23. A system as defined in claim 20, wherein the electronics module further comprises a connector plug that connects to a receptacle on the internal electronics module.

24. A system as defined in claim 23, wherein the connector plug is configured to form a snap connection, a magnetic connection, or both a snap connection and a magnetic connection with the receptacle on the internal electronics module.

25. A system as defined in claim 20, wherein the interactive object further comprises a plurality of conductive threads woven into the interactive object, the internal electronics module being coupled to the plurality of conductive threads.

26. A system as defined in claim 25, wherein the internal electronics module comprises sensing circuitry configured to detect touch-input to the plurality of conductive threads.
